(19) United States
(12) Patent Application Publication
(10) Pub. No.: US 2019/0093488 A1
(43) Pub. Date: Mar. 28, 2019

(54) AEROFOIL COMPONENT AND METHOD

(71) Applicants: ROLLS-ROYCE PLC, London (GB); ROLLS-ROYCE CORPORATION, Indianapolis, IN (US)

(72) Inventors: Mark DIXON, Derby (GB); Timothy UNTON, Avon, IN (US)

(73) Assignees: ROLLS-ROYCE PLC, London (GB); ROLLS-ROYCE CORPORATION, Indianapolis, IN (US)

(21) Appl. No.: 16/130,353

(22) Filed: Sep. 13, 2018

Related U.S. Application Data
(60) Provisional application No. 62/561,729, filed on Sep. 22, 2017.

(51) Int. Cl. F01D 5/28; F01D 5/14

(52) U.S. Cl. CPC F01D 5/282; F01D 5/147; F05D 2300/6032; F05D 2230/42; F05D 2230/25; F05D 2230/24; F05D 2230/26; F05D 2300/174

(57) ABSTRACT

There is a described an aerofoil component for a turbomachine, the aerofoil component comprising: a central core formed from a metal matrix composite; and an external layer comprising a pressure surface, a suction surface, a leading edge, a trailing edge and a root, the external layer being formed by a metal which covers the metal matrix composite of the central core. Also described is a method of manufacturing such an aerofoil component.

### CROSS-REFERENCE TO RELATED APPLICATIONS

This specification is based upon and claims the benefit of priority from U.S. Provisional Patent Application No. 62/561729 filed on 22 Sep. 2017, the entire contents of which are incorporated herein by reference.

### TECHNICAL FIELD

The present disclosure concerns an aerofoil component of a turbomachine and a method of manufacturing an aerofoil component for a turbomachine.

### BACKGROUND

Turbomachines, such as gas turbine engines, use rotors which comprise a plurality of aerofoil components, typically referred to as blades. Such rotors may be used, for example, in the fan, compressors and turbines. The blades are often welded to a central disk or ring to form a monolithic component referred to as a blisk (bladed disk) or bling (bladed ring).

The blades are typically manufactured from Titanium, such as Titanium 6AI-4V (Ti6-4), and are welded to the disk or ring using a solid state welding process, such as linear friction welding. The disk or ring is also typically formed of Titanium and so the resulting component is formed of a single material.

Titanium can be limited in its high cycle fatigue capability and this produces limitations in the design. These limitations result in additional thickness in the aerofoil form, reducing fan efficiency and adding additional weight in the component. Compressor aerofoils are also affected by phenomenon such as aerodynamic flutter which, in order to protect against such events, presents further such design limitations.

It is therefore desired to provide an aerofoil component which addresses these issues.

### SUMMARY

According to an aspect there is provided an aerofoil component for a turbomachine, the aerofoil component comprising: a central core formed from a metal matrix composite; and an external layer comprising a pressure surface, a suction surface, a leading edge, a trailing edge and a root, the external layer being formed by a metal which covers the metal matrix composite of the central core.

The external layer may further comprise a tip such that the external layer entirely encapsulates the metal matrix composite of the central core.

The metal matrix composite may comprise a reinforcing material in a metal matrix.

The metal matrix may be formed from the same metal as the external layer. In some examples, the metal matrix may be formed from the same base metal as the external layer, but may be formed from a different alloy. However, in other examples, the same alloy may be used for both the metal matrix and the external layer.

The reinforcing material may be a particulate material.

The reinforcing material may be titanium boride or titanium carbide.

The external layer may be formed from titanium (including alloys of titanium).

A plurality of aerofoil components may be used to form a rotor. The aerofoil components may be joined to a hub via the root. For example, the aerofoil components may be joined to the hub using solid state welding or diffusion bonding.

The central core of one or more of the aerofoil components may be spaced a radial distance from its root which is different to that of one or more of the other aerofoil components.

According to another aspect there is provided a method of manufacturing an aerofoil component for a turbomachine, the method comprising: covering a central core formed from a metal matrix composite within an external layer formed by a metal to form a blank; consolidating the blank to form an intermediate form; and forging the intermediate form to form the aerofoil component with the external layer surrounding the central core of metal matrix composite and forming a pressure surface, a suction surface, a leading edge, a trailing edge and a root.

The external layer may additionally form a tip such that the external layer entirely encapsulates the metal matrix composite of the central core.

The blank may be consolidated by extrusion.

The blank may be consolidated by rolling.

The blank may be consolidated by hot isostatic pressing.

The intermediate form may be cut prior to forging so as to determine a radial distance of the central core from the root in the forged aerofoil component.

The method may further comprise connecting a plurality of said aerofoil components to a hub to form a rotor, wherein the central core of one or more of the aerofoil components is spaced a radial distance from its root which is different to that of one or more of the other aerofoil components.

A plurality of central cores may be covered by the external layer, and the method may further comprise: cutting the intermediate form into a plurality of sections each comprising a central core covered by the external layer and then forging the sections to form a plurality of aerofoil components.

The skilled person will appreciate that except where mutually exclusive, a feature described in relation to any one of the above aspects may be applied mutatis mutandis to any other aspect. Furthermore except where mutually exclusive any feature described herein may be applied to any aspect and/or combined with any other feature described herein.

### BRIEF DESCRIPTION OF THE DRAWINGS

Embodiments will now be described by way of example only, with reference to the Figures, in which:

FIG. 1 is a sectional side view of a gas turbine engine;

FIG. 2 is a perspective view of a fan blade of the gas turbine engine;

FIG. 3 is a flowchart of a method of manufacturing a fan blade;

FIG. 4 is a cross-sectional view of a blank used to manufacture the fan blade;

FIG. 5 is an alternative blank used to manufacture the fan blade;

FIG. 6 is a cross-sectional view of the blank of FIG. 4 or 5 following a consolidation operation; and

FIG. 7 is a cross-sectional view of the consolidated blank following extrusion.

### DETAILED DESCRIPTION OF THE DISCLOSURE

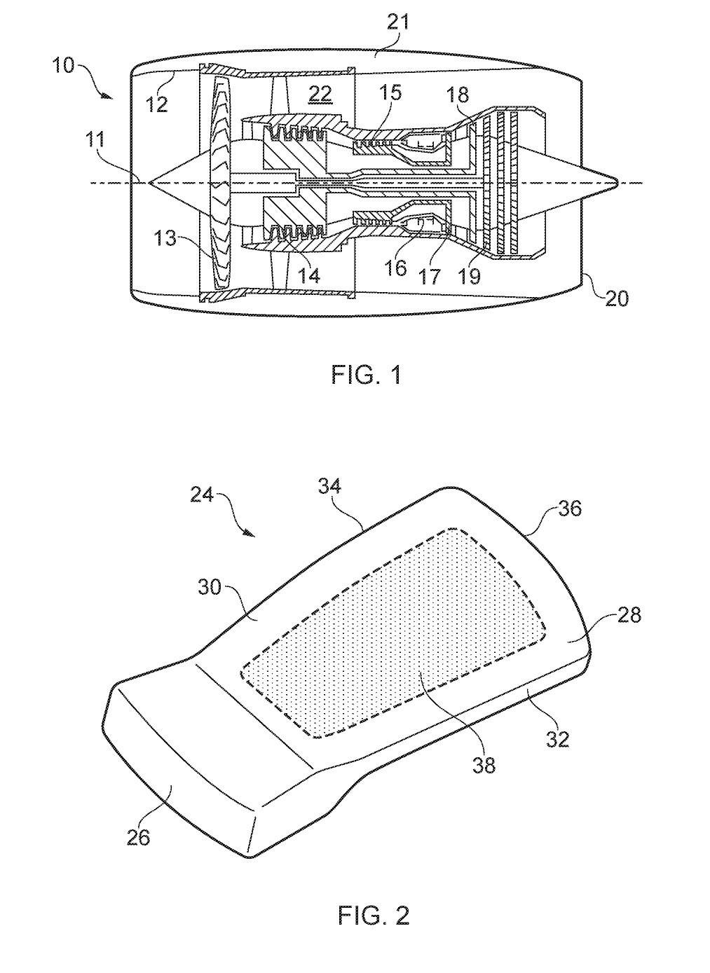

With reference to FIG. 1, a gas turbine engine is generally indicated at 10, having a principal and rotational axis 11. The engine 10 comprises, in axial flow series, an air intake 12, a propulsive fan 13, an intermediate pressure compressor 14, a high-pressure compressor 15, combustion equipment 16, a high-pressure turbine 17, an intermediate pressure turbine 18, a low-pressure turbine 19 and an exhaust nozzle 20. A nacelle 21 generally surrounds the engine 10 and defines both the intake 12 and the exhaust nozzle 20.

The gas turbine engine 10 works in the conventional manner so that air entering the intake 12 is accelerated by the fan 13 to produce two air flows: a first air flow into the intermediate pressure compressor 14 and a second air flow which passes through a bypass duct 22 to provide propulsive thrust. The intermediate pressure compressor 14 compresses the air flow directed into it before delivering that air to the high pressure compressor 15 where further compression takes place.

The compressed air exhausted from the high-pressure compressor 15 is directed into the combustion equipment 16 where it is mixed with fuel and the mixture combusted. The resultant hot combustion products then expand through, and thereby drive the high, intermediate and low-pressure turbines 17, 18, 19 before being exhausted through the nozzle 20 to provide additional propulsive thrust. The high 17, intermediate 18 and low 19 pressure turbines drive respectively the high pressure compressor 15, intermediate pressure compressor 14 and fan 13, each by suitable interconnecting shaft.

Other gas turbine engines to which the present disclosure may be applied may have alternative configurations. By way of example such engines may have an alternative number of interconnecting shafts (e.g. two) and/or an alternative number of compressors and/or turbines. Further the engine may comprise a gearbox provided in the drive train from a turbine to a compressor and/or fan.

FIG. 2 shows a blade 24 of the fan 13. As shown, the blade 24 generally comprises a root portion 26 and an aerofoil portion 28. The root portion 26 is used to attach the blade 24 to a hub of the fan 13 in the form of a ring or disk.

The aerofoil portion 28 comprises a pressure surface 30 and an opposing suction surface (not visible). A leading edge 32 and a trailing edge 34 are defined between the opposing pressure and suction surfaces along the lateral sides of the aerofoil portion 28. The aerofoil portion 28 extends the root portion 26 to a tip 36 at its distal, free end.

The blade 24 is fabricated from a composite material. Specifically, the root portion 26 and the external surfaces of the aerofoil portion 28 (i.e. the pressure and suction surfaces, the leading and trailing edges, and the tip) are formed from a first material. A central core 38 formed from a second material is provided within the aerofoil portion 28 and surrounded by the first material. The central core 38 extends in a span wise direction between the root portion 26 and the tip 36, and in a chord wise direction between the leading and trailing edges 32, 34.

The first material is a metal or metal alloy. Specifically, in this example, the first material is Ti6-4. The second material is a metal matrix composite consisting of a metal matrix and a reinforcing material. In this example, the reinforcing material is a particulate material which may be formed from, for example, a ceramic, such as TiC or TiB. The metal matrix is formed from the same material as the first material and so is also Ti6-4 in this example. In other examples, the metal matrix may be formed from the same base metal, but a different alloy.

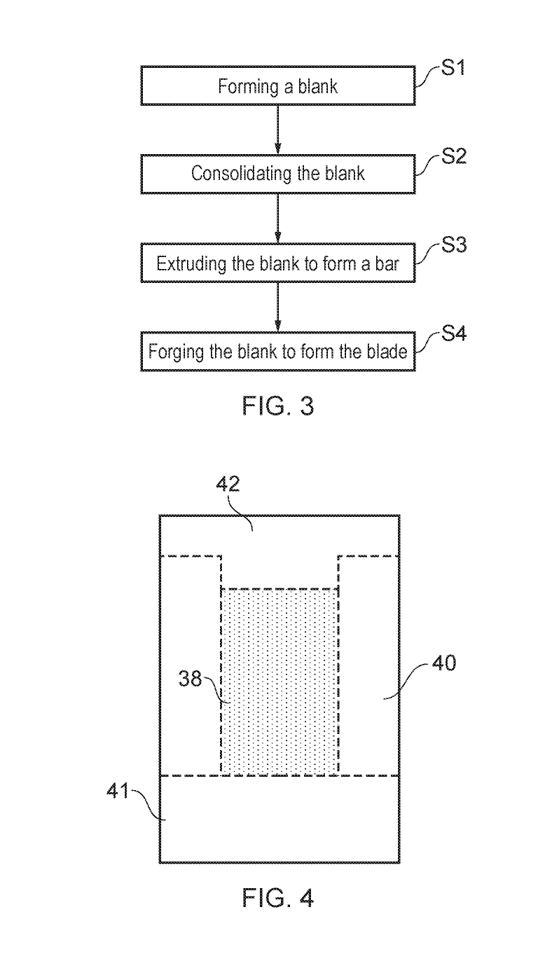

FIG. 3 shows a flowchart describing a method of manufacturing the blade 24 which will now be described with reference to FIGS. 4 to 7.

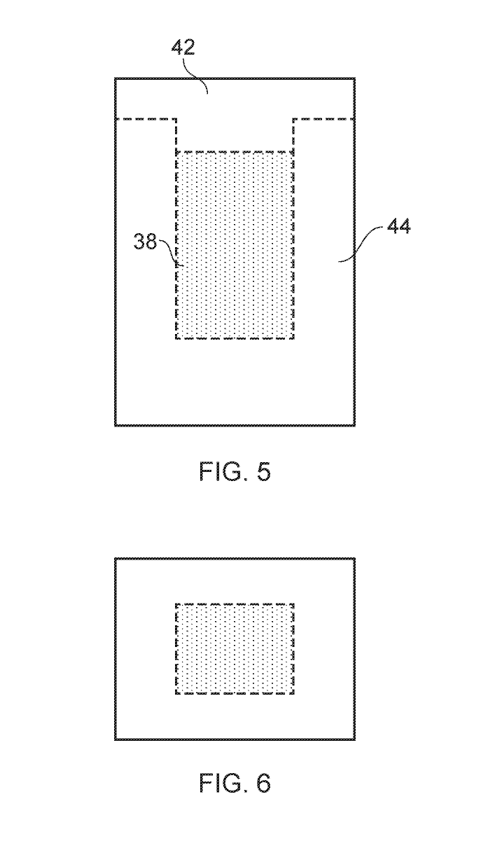

In step 1, a blank is formed which comprises the first material (i.e. the metal or metal alloy) and the second material (i.e. the metal matrix composite). This may be achieved as shown in FIG. 4 or 5.

In FIG. 4, a thick walled tube 40 formed from the first material is provided. The tube 40 is closed at its lower end by a base 41, also formed from the first material, producing a cavity there within. The core 38 formed from the second material is inserted into the cavity and the cavity is then closed by a lid 42 formed from the first material which is placed over the opposite end of the tube 40. The core 38 formed from the second material is thus encapsulated within the first material.

In FIG. 5, the tube 40 and base 41 are effectively integrally formed by machining a cavity in a solid billet 44 of the first material. In the same manner as described previously, the core 38 is then inserted into the cavity and the cavity is closed by a lid 42.

In step 2, the blank of FIG. 4 or 5 is consolidated to form an integral component (intermediate form), as shown in FIG. 6. Specifically, the blank may be hot isostatically pressed (HIP) using established procedures to consolidate the first and second materials such that they are bonded together. The second material is therefore clad with the first material.

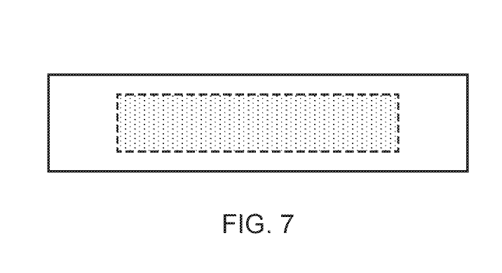

In step 3, the consolidated blank is then extruded (using conventional procedures) to form a bar, as shown in FIG. 7. The bar may instead be formed by rolling. In other examples, the extrusion or rolling step may be used to consolidate the blank such that steps 2 and 3 are combined into a single process.

The extruded bar is then forged to form the blade 24 in step 4. The blades 24 may be forged close to the final required aerodynamic size and shape. However, the blades 24 may undergo some final finishing, post forging, such as machining, welding, heat treating, polishing and inspection.

In another example, the tube 40 of FIG. 4 or billet 44 of FIG. 5 may receive a plurality of cores 38 which are separated by spacer plugs formed from the first material. The blank may be consolidated as described above and then cut into a plurality of sections each comprising a core 38 of second material encapsulated within the first material which are then forged to form a plurality of aerofoil components.

The blade 24 is selectively reinforced, comprising a reinforced core, but with all outer surfaces being unreinforced, including the root and tip. The central core 38 reinforces the blade 24, thereby increasing its stiffness. Consequently, the fatigue loading and the susceptibility to flutter is reduced compared to a blade formed entirely from the first material. However, the first material is used for all external surfaces of the blade 24, particularly the root portion 26 and so allows existing linear friction welding parameters to be used to attach the blade 24 to the hub.

The increased stiffness due to the reinforcement of the aerofoil portion 28 reduces the fatigue stress at the peak limiting location for a given engine load, resulting in an increased component life.

Alternatively, the blade 24 could be redesigned to reduce the thickness of the aerofoil portion 28 (while retaining the same stiffness) to improve the aerodynamic efficiency of the fan 13.

The blade 24 utilises a material with good damage tolerance properties (e.g. Ti6-4) on the leading edge where the blade 24 is susceptible to foreign object damage (FOD), while the overall blade 24 benefits from the strength and stiffness of the core 38.

Further, having a leading edge formed from a single material (e.g. Ti) allows the use of existing material addition repair techniques, thereby reducing the life cycle cost of the component.

The specific method described above provides a blade having a reinforced core, whilst utilising existing extrusion and forging techniques.

The second material is chosen to provide the required increase in stiffness, but with a flow stress that is well matched to the first material during the extrusion step.

The method also allows the radial position of the reinforcing core 38 to be varied simply by selecting the appropriate cutting position during preparation of the extruded bar for forging. This presents the opportunity to produce a set of blades 24 that are deliberately “mis-tuned” (i.e. their individual dynamic response is different). This may reduce the risk of flutter and enable a lighter or more efficient design capable of meeting the required design criteria for flutter.

Although the first material has been described as being a titanium alloy, it will be appreciated that other materials could be used. Similarly, other materials with increased stiffness which are capable of being bonded (either directly or indirectly) to the base material during the HIP stage (or via any other consolidation process) and capable of being extruded during the extrusion stage may be used for the core.

Although the blade has been described with reference to a fan rotor, it will be appreciated that it may be used in other aerofoil components, particularly for blades found elsewhere in a gas turbine engine, such as in compressors and turbines. It may also be used in other types of turbomachines, such as steam turbines.

Although it has been described that the core is entirely encapsulated within the first material, in other examples the core may only be partially covered by the external layer of first material. In particular, the core may be exposed at its tip.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

We claim:

1. An aerofoil component for a turbomachine, the aerofoil component comprising:
a central core formed from a metal matrix composite; and
an external layer comprising a pressure surface, a suction surface, a leading edge, a trailing edge and a root, the external layer being formed by a metal which covers the metal matrix composite of the central core.

2. An aerofoil component as claimed in claim 1, wherein the external layer further comprises a tip such that the external layer entirely encapsulates the metal matrix composite of the central core.

3. An aerofoil component as claimed in claim 1, wherein the metal matrix composite comprises a reinforcing material in a metal matrix.

4. An aerofoil component as claimed in claim 3, wherein the metal matrix is formed from the same metal as the external layer.

5. An aerofoil component as claimed in claim 3, wherein the reinforcing material is a particulate material.

6. An aerofoil component as claimed in claim 3, wherein the reinforcing material is titanium boride or titanium carbide.

7. An aerofoil component as claimed in claim 1, wherein the external layer is formed from titanium.

8. A rotor comprising a plurality of aerofoil components as claimed in claim 1.

9. A rotor as claimed in claim 8, wherein the aerofoil components are joined to a hub via the root.

10. A rotor as claimed in claim 8, wherein the central core of one or more of the aerofoil components is spaced a radial distance from its root which is different to that of one or more of the other aerofoil components.

11. A method of manufacturing an aerofoil component for a turbomachine, the method comprising:
covering a central core formed from a metal matrix composite with an external layer formed by a metal to form a blank;
consolidating the blank to form an intermediate form; and
forging the intermediate form to form the aerofoil component with the external layer surrounding the central core of metal matrix composite and forming a pressure surface, a suction surface, a leading edge, a trailing edge and a root.

12. A method as claimed in claim 11, wherein the external layer additionally forms a tip such that the external layer entirely encapsulates the metal matrix composite of the central core.

13. A method as claimed as claim 11, wherein the blank is consolidated by extrusion.

14. A method as claimed as claim 11, wherein the blank is consolidated by rolling.

15. A method as claimed in claim 11, wherein the blank is consolidated by hot isostatic pressing.

16. A method as claimed in claim 11, wherein the intermediate form is cut prior to forging so as to determine a radial distance of the central core from the root in the forged aerofoil component.

17. A method as claimed in claim 16, further comprising connecting a plurality of said aerofoil components to a hub to form a rotor, wherein the central core of one or more of the aerofoil components is spaced a radial distance from its root which is different to that of one or more of the other aerofoil components.

18. A method as claimed in claim 11, wherein a plurality of central cores are covered by the external layer, the method further comprising cutting the intermediate form into a plurality of sections each comprising a central core covered by the external layer and then forging the sections to form a plurality of aerofoil components.
